(19) United States
(12) Patent Application Publication
(10) Pub. No.: US 2006/0125608 A1
(43) Pub. Date: Jun. 15, 2006

(54) Signalling device to make the administering of medical preparations easier

(76) Inventor: Rainer Fritz Robert Doll, Duvenbornsweg (DE)

Correspondence Address: VIERING JENTSCHURA & PARTNERS, 3770 HIGHLAND AVENUE, SUITE 203, MANHATTAN BEACH, CA, 90266, US

(21) Appl. No.: 10/521,291

(22) PCT Filed: Jul. 11, 2003
(86) PCT No.: PCT/EP03/07545

§ 371 Date: Aug. 15, 2005

(30) Foreign Application Priority Data
Jul. 15, 2002 (HU) U 0200210

(51) Int. Cl. G08B 1/00

(52) U.S. Cl. 340/309.3

(57) ABSTRACT

A signalling device to make the administering of medical preparations easier, especially to signal the set administering time point of medicines, which contains a house, a data input unit placed in the house, a display unit and memory unit as well as a control unit in connection with these and a power supply, the memory unit has a basic storage register and a personal data storage register wherein the memory unit (30) is supplemented with a time data storage register (32), while the control unit (20) is supplemented with a counting part-unit (21) and comparison part-unit (22), furthermore, the control unit (20) is connected to an alarm part-unit (50), the input (22a) of the comparison part-unit (22) is connected to the time data storage register (33) and the counting part-unit (21), and the output (22b) of the comparison part-unit (22) is directly connected to the alarm part-unit (50) or via the control unit (20).

The subject of the invention relates to a signalling device to make the administering of medical preparations easier, especially to signal the set administering time point of medicines, which contains a house, a data input unit placed in the house, a display unit and memory unit, as well as a control unit in connection with these and a power supply, the memory unit has a basic storage register and a personal data storage register.

Due to the development of pharmaceutical chemistry and medical science pharmaceuticals have been developed for the curing of an increasing number of illnesses or the treatment of their symptoms. The essence of these is that depending on the amount and effect mechanism of the active agent, the medical preparation it to be administered orally at a determined frequency, in the prescribed amount in the form of a solution or tablet, or administered in the form of an injection into the body, or used in another way. In the case of a high number of medicines and varying administration intervals, furthermore, in the case of the elderly it may be a problem to use the prescribed preparation in the appropriate amount and at the desired point in time.

Patent specification HU 215.227 presents a device for the dosing out of various medicines to a given person, the essence of which is that the amounts and types of the medicines according to the treatment given are determined with the help of an identifier assigned to a given patient, which, following this, with the help of a dosage device, are placed into a storage vessel, checked and only following this are they given to the person being treated.

The advantage of this solution is that in the case of a large number of patients and numerous types of medicine the danger of the administering of the incorrect medicine is reduced and the work and responsibility of the nursing staff administering the medicines is moderated.

However, its disadvantage is that it can not be used in the case of persons undergoing long-term treatment, and the suffering from a chronic disease but who are free to move and carry out work. Another disadvantage is that the known device is not suitable for warning the individual patients to take the various medicines at the set time, for calling the attention of the patient to an abnormality in the case a medicine is not taken, and in the case it is necessary to attract the attention of those persons in the vicinity of the patient.

Vessels containing several compartments suitable for the storage of medicines that have been dosed out are also known of, in which vessels the preparations to be taken at various times are grouped according to the time of the day. The disadvantage of these is, however, that similarly to those mentioned previously they do not emit a signal in the case a medicine is not taken, and so they are not able to give a warning at the time when a given medicine is to be taken, either.

With the signalling device according to the invention our aim was to overcome the deficiencies of the known solutions and to create a version with the help of which it is possible to warn the, person undergoing treatment to take the required medical preparation at the prescribed time, and over and above this, in the case of necessity for the data of the active agent to be administered at the given point in time to be easily accessible to an external party, e.g. a nurse or doctor.

The recognition that led us to the arrangement according to the invention was that if the names of the medicines and their dosage times are fed into a uniquely set up memory unit that is in connection with electronic elements, and the time point data stored there is compared to a signal provided by a time measuring device in a continuous cycle then the task can be solved. As due to the development of electronics and computing electronic construction elements have gone through such a degree of size reduction that provides the possibility to realise the solution described previously in very small physical dimensions.

In accordance with the set aim the signalling device according to the invention to make the administering of medical preparations easier, especially to signal the set administering time point of medicines,—which contains a house, a data input unit placed in the house, a display unit and memory unit, as well as a control unit in connection with these and a power supply, the memory unit has a basic storage register and a personal data storage register,—is set up in such a way that the memory unit is supplemented with a time data storage register, while the control unit is supplemented with a counting part-unit and comparison part-unit, furthermore, the control unit is connected to an alarm part-unit, the input of the comparison part-unit is connected to the time data storage register and the counting part-unit, and the output of the comparison part-unit is directly connected to the alarm part-unit or via the control unit.

A further criterion of the signalling device according to the invention may be that the house is fitted with a fixing component, and the fixing component is connected to the alarm part-unit.

In a possible embodiment of the signalling device the power source is coupled to a supplementary energy store.

In a still further different construction form of the invention the data input unit has a function select component, a scrolling component and acknowledgement component, the function select component, the scrolling component and the acknowledgement component are push buttons, furthermore the data input unit has a delete component, data fetching component and start component, the delete component, data fetching component and start component are push buttons.

In another different version of the signalling device the alarm part-unit has a sound signalling component and/or light signalling component and/or mechanical signalling component.

The signalling device according to the invention has numerous advantageous characteristics. The most important of these is its simple operation and large number of signalling time points in spite of its small size, as well as the medical preparation that can be assigned to the time points, also it is suitable for the recording and storage of the important data of the person using it, so at the pre-programmed time it does not only warn the user of the device to take his/her medicine, but also gives the name and amount of the preparation to be used at that time point.

Another advantage is that the suitably set up alarm part-unit may give out several types of signal at the same time, which makes it easier to notice, and so it gives an even more efficient warning to the person undergoing treatment.

Also to be listed among the advantages is that due to the storage of the personal data, the illness related to this and the names of the life-saving medicine, as well as the modern set up of the signalling device, it can not Dust be used for warning but also as a unit that calls for help, as in the case that the warning signal is not reset, when determined conditions arise the signalling device automatically gives out a general alarm, which also calls the attention of the persons in the vicinity of the patient to itself, and these persons can give help to the person in need on the basis of the instructions on the signalling device.

Another advantage is that the signalling device according tot he invention can be easily manufactured, easily operated, programmed, furthermore, its maintenance requirement is small, and this does not require training nor specialist knowledge.

Due to the arrangement of the signalling device it has small dimensions, which assists in its positioning, so it may be carried in the pocket or on a belt, and due to this at every moment it can be in the immediate vicinity of the person undergoing treatment, advantageously on his/her clothing, which further increases its effectiveness.

In the following we present the signalling device according to the invention in detail on the basis of a drawing. On the drawing:

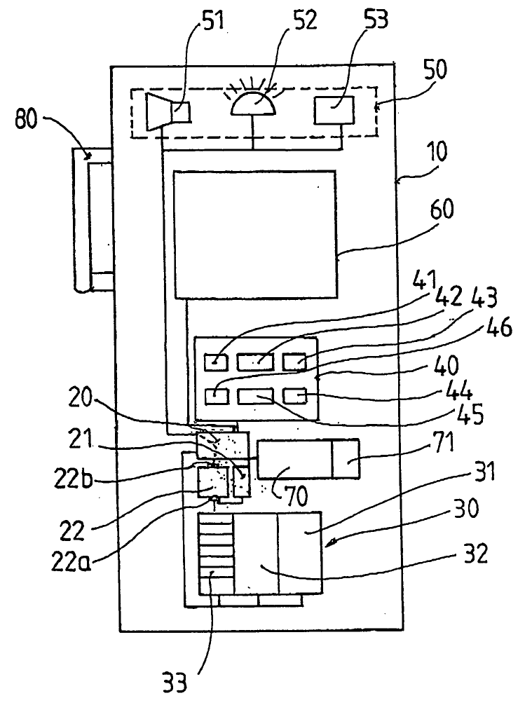

FIG. 1 shows a block sketch of a possible version of the signalling device according to the invention.

On FIG. 1 an embodiment of the signalling device according to the invention can be seen in which the external surface of the house 10 has a fixing component 80. Due to this fixing component 80 the house 10 and so the signalling device itself can be attached to a belt. The house 10 contains the alarm part-unit 50, which in this case has a sound signalling component 51, a light signalling component 52 and a mechanical signalling component 53. These may enter into operation independently of each other, but also at the same time as well, depending on how the user sets up the alarm part-unit 50.

The house 10 also contains the display unit 60, which in this case is a multi-line LCD display, furthermore, a data input unit 40, which here is formed from a set of push buttons that have various functions. Parts of the data input unit 40 include the function select component 41, the scroll component 42, the acknowledgement component 43 and, in this embodiment, the delete component 44, the data fetch component 45 and the start component 46 as well. We have to mention here that the data input unit can be set up from switching elements that differ n operation principle from that of push buttons, and the number of switching elements, their function assignment and arrangement can differ from the version presented in the example. Its essence, however, is for external information to be able to be fed into the memory unit 30 with the help of the data input unit 40 via the control unit, and for the data that has been fed in to be displayed and changed.

Naturally, the control unit 20 and the memory unit 30 are also in the house 10. Here the memory unit 30 can be divided into three parts; into the basic storage register 31, the personal data storage register 32 and the time data storage register 33. The basic storage register 31 is preferably EPROM, and contains data pre-programmed on manufacture, such as the letters belonging to the various languages and numbers. It is preferable if the personal data storage register 32 and the time data storage registers 33 are RAM. The personal data storage register 32 serves for the storage of the important data of the user, such as especially the user's name, insurance number, blood group, data on the names of illnesses and the names of any life-saving medicines and their amounts, while the time data storage register 33 can be used to record the names of the medical preparations used by the user, their dosages and their time to be taken or otherwise used.

The control unit 20 has a programmable microprocessor, and its task is the harmonisation of the memory unit 30, the data input unit 40, the alarm part-unit 50 and the display unit 60 and to ensure the desired operation. In the interest of this the control unit 20 is connected to the power source 70, which energy source 70 provides the necessary electrical energy for the operation of the memory unit 30, the alarm part-unit 50 and the display unit 60 as well as for the data input unit 40 as well. In the interest of increasing safety and avoiding accidental data loss beside the energy source 70, the house 10 also contains a supplementary energy store 71, which preferably consists of two cadmium batteries.

As can be easily seen in FIG. 1, the counting part-unit 21 and the comparison part-unit 22 also belong to that control unit 20. In essence the counting part-unit 21 is a continuously operating internal clock, which is connected to the input 22a of the comparison part-unit 22. The time data storage register 33 is also in connection with the input 22a of the comparison unit 22, while the output 22b of the comparison unit 22—in this embodiment—is connected to the alarm part-unit 50 via the control unit 20.

Here we have to mention that the lock of the fixing component 80 may be connected to the alarm part-unit 50, which may be advantageous because if someone were to take the house 10 off the belt connected to the fixing component 80 without authorisation, then the alarm part-unit 50 automatically signals the theft attempt.

During the use of the signalling device according to the invention after first switching it on—advantageously—instructions programmed during manufacture appear on the display unit 60, on the basis of which instructions the user may input his/her own important data with the help of the data input unit 40 into the personal data storage register 32 of the memory unit 30. For this the user displays the desired “ABC” letters with the help of the function select component 41 and then with the help of the scroll component 42—in a way that is known in itself in connection with other devices—he/she selects the desired letter or number and confirms this with the acknowledgement component 43, then in the same way as before inputs the next letter.

After filling up the personal data storage register 32 with the help of the function select component 41 a series of operations can be set in motion in which the medicines and other medical preparations used by the given person can be programmed into the time data storage register 33 of the memory unit 30, furthermore, the times they are to be taken or used and the amounts to be taken or used. In order to input the data the function select component 41, the scroll component 42, the acknowledgement component 43, the delete component 44 and, in a given case, the data fetch component 45 of the data input unit 40 are used. When this phase of the programming has been completed, then the signalling device is ready for operation.

When operating the signalling device comparison part unit 22 of the control unit 20 compares the time signal continuously arriving at its input 22a from the counting part-unit 21 with the programmed time data also arriving at the input 22a from the time data storage register 33. If the time signal appearing at the input 22a of the comparison part-unit 22 and coming from the counting part-unit 21, and the time data received from the time data storage register 33 are the same, then an instruction signal appears at the output 22b of the comparison part-unit 22, which either directly or—as in the present version—via the control unit 20 sets off the alarm part-unit 50. The alarm part-unit 50 warns the owner of the signalling device with the help of sound, light and vibration that the time has come to use a preparation. Beside switching on the alarm part-unit 50 the control unit 20 displays the record—programmed in previously—belonging to the given time point on the display unit 60, so the user can also see what preparation he/she has to take.

The signals given by the alarm part-unit 50 are maintained for a given period, then stop for a short time. In the case that someone does not push the acknowledgement component 43 of the data input unit 40, the alarm part-unit 50 is set off again. In the case a pre-determined number of repetitions is reached irrespective of the earlier settings the alarm part-unit 50 of the signalling device automatically switches on the sound signalling component 51, the light signalling component 52 and the mechanical signalling component 53 together, it even operates the sound signalling component 51 at its highest volume. Over and above this it displays the data of the user stored in the personal data storage register 32 of the memory unit 30 on the display unit 60.

This emergency, alarm function of the signalling device is maintained until someone presses the acknowledgement component 43 of the data input unit 40, or until the energy source 70 and the supplementary energy store 71 run out.

In the case of using a new preparation the time data storage register 33 of the memory unit 30 can be supplemented, or the data stored there overwritten or corrected. This operation can be carried out using the function select component 41, the scroll component 42, the acknowledgement component 43, the delete component 44, the data fetch component 45 and the start component 46 of the data input unit 40. The work being carried out can be seen on the display unit 60.

The signalling device according to the invention can be applied well in all cases when it is favourable to warn people undergoing treatment to use the prescribed medical preparations at given times, and in the case of those persons who are undergoing continuous treatment and their illness can involve loss of consciousness, or such serious conditions as a consequence of which they are not able to take life-saving medicine themselves.

1. A signalling pocket device to signal the set administering time point of medicines for a user, comprising:
a house (10);
a data input unit (40) placed in a wall of the house (10), the data input unit (40) including switching elements, in particular push buttons, directly operateable at the signalling pocket device by the user;
a multi-line display unit (60) contained in the house (10);
a memory unit (30) contained in the house (10);
an alarm part-unit (50) contained in the house (10);
a control unit (20) contained in the house (10) and in connection with the data input unit (40), the display unit (60), the memory unit (30) and the alarm part-unit (50); and
a power supply (70) contained in the house (10);
wherein the control unit (20) has a counting part-unit (21) and a comparison part-unit (22);
wherein the memory unit (30) includes a basic storage register (31) being pre-programmed on manufacture with instructions, letters and numbers, a personal data storage register (32) for storing the user, s personal data and a time data storage register (33) for storing administering data for the user's medicines, the personal data storage register (32) and the time data storage register (33) being random access memories;
wherein the switching elements of the data input unit (40) include a function select component (41), a scrolling component (42) and an acknowledgement component (43), and wherein the data input unit (40) is adapted to program the personal data storage register (32) and the time data storage register (33) on basis of the instructions, letters and numbers stored in the basic storage register (31) and input by the user via the switching elements;
wherein the alarm part-unit (50) has a sound signalling component (51), a warning light signalling component (52) and a vibrational signalling component (53), and is settable for an operation of the sound signalling component (S1), the warning light signalling component (52) and the vibrational signalling component (53) independently of each other or at the same time;
wherein the alarm part-unit (50) and the display unit (60) are controlled by the control unit (20), when the set administering time point of a medicine is reached, to give alarm for a predetermined period and to display a previously programmed record about the medicines to be taken, respectively; and
wherein the alarm part-unit (50) and the display unit (60) are controlled by the control unit (20), if the set administering time point of medicines for the user is not acknowledged via the acknowledgement component (43) and when a predetermined number of repetitions of warning signals appeared, to operate the sound signalling component (51) at its highest volume and the warning light signalling component (S2) and the vibrational signalling component (53) simultaneously as a general alarm, and to display the personal data of the user stored in-the personal data storage register (32), respectively.

2. The signalling pocket device according to claim 1, characterised in that the power source (70) is coupled to a supplementary energy store (71) contained in the house (10) for supplying power to the signalling pocket device even if the power source (70) is empty to guarantee that the user is safely signalled.

3. The signalling pocket device according to claim 1, characterized in that the house (10) is fitted with a fixing component (80), and the fixing component (80) is connected to the alarm part-unit (50) for signalling unauthorized removal of the signalling pocket device.

4. The signalling pocket device according to claim 2, characterized in that the house (10) is fitted with a fixing component (80), and the fixing component (80) is connected to the alarm part-unit (50) for signalling unauthorized removal of the signalling pocket device.

5. The signalling pocket device according to claim 1, characterized in that the switching elements of the data input unit (40) further include a delete component (44), a data fetching component (45) and a start component (46).

6. The signalling pocket device according to claim 2, characterized in that the switching elements of the data input unit (40) further include a delete component (44), a data fetching component (45) and a start component (46).

7. The signalling pocket device according to claim 3, characterized in that the switching elements of the data input unit (40) further include a delete component (44), a data fetching component (45) and a start component (46).

8. The signalling pocket device according to claim 4, characterized in that the switching elements of the data input unit (40) further include a delete component (44), a data fetching component (45) and a start component (46).
